(19) United States
(12) Patent Application Publication
(10) Pub. No.: US 2008/0211375 A1
(43) Pub. Date: Sep. 4, 2008

(54) FIELD EMITTER AND METHOD OF OPERATING THE SAME

(75) Inventors: Jun-Ho Choi, Yongin-si (KR); Chang-Woong Chu, Suwon-si (KR); Jae-Kook Ha, Yongin-si (KR); Choon-Sup Yoon, Daejeon (KR); Sang-Jin Ahn, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/859,281

(22) Filed: Sep. 21, 2007

(30) Foreign Application Priority Data
Sep. 22, 2006 (KR) 2006-92071

(51) Int. Cl. H01J 1/02

(52) U.S. Cl. 313/309

(57) ABSTRACT

A field emitter includes a cathode, a field emission point part, a first anode, a charge storing plate, and a second anode. The field emission point part faces the first anode and is disposed at a first surface of and electrically connected to the cathode. The charge storing plate is disposed at a second surface, opposite the first surface, of the cathode. The second anode faces the second surface of the cathode. The charge storing plate is interposed between the second anode and the second surface of the cathode. Even if substantially the same electric field is formed in the field emitter as in a field emitter without the charge storing plate, the field emitter having the charge storing plate induces a more effective field emission current than the field emitter without the charge storing plate.

This application claims priority to Korean Patent Application No. 2006-92071, filed on Sep. 22, 2006, and all the benefits accruing therefrom under 35 U.S.C. § 119, the contents of which in its entirety are herein incorporated by reference.

### BACKGROUND OF THE INVENTION

1. Field of the Invention

The present invention relates to a field emitter and a method of operating the field emitter. More particularly, the present invention relates to a field emitter capable of increasing electron density and a method of operating the field emitter.

2. Description of the Related Art

A field emitter includes a cathode and an anode that face each other. The cathode and the anode basically include a field emission point part. When an electric field is applied between the cathode and the anode, electrons are emitted from the cathode. The emitted electrons flow between the cathode and the anode by the electric field, and form a field emission current. The amount of the field emission current is proportional to electron charge density and field emission probability density.

The field emission probability density is determined by the Fowler-Nordheim equation. The Fowler-Nordheim equation can be found in the reference: R. H. Fowler; L. Nordheim., Proceedings of the Royal Society London, Vol. 119, 173 (1928). The equation shows that a strong electric field is required for effective induction of field emission. Thus, a strong electric field is applied to the field emission point part for increasing an amount of emitted current.

In order to apply the strong electric field to the field emission point part, in general, the field emission point part is made as acute as possible.

The field emission point part includes molybdenum Mo or tungsten W.

The field emitter is used in various fields such as field emission display, cathode ray tube, transmission electron microscopy, scanning electron microscopy, electron beam lithography, etc. However, the conventional field emitter is limited to a structure design of a field emission point part having a large electric field under a given applied voltage (e.g., see Alper Buldum and Jian Ping Lu, Physical Review Letters, Vol. 91, 236801 (2003)).

### BRIEF SUMMARY OF THE INVENTION

Thus, the present invention provides a field emitter capable of enhancing field emission.

The present invention also provides methods of operating the field emitter and enhancing field emission of a field emitter.

In exemplary embodiments of the present invention, a field emitter includes a cathode, a field emission point part, a first anode, a charge storing plate, and a second anode. The field emission point part is disposed on a first surface of the cathode and is electrically connected to the cathode. The first anode faces the field emission point part. The charge storing plate is disposed on the second surface of the cathode. The second surface is opposite to the first surface. The second anode faces the second surface of the cathode. The charge storing plate is interposed between the second anode and the second surface of the cathode.

The charge storing plate, for example, may include ferroelectric and the ferroelectric may include a perovskite crystalline structure.

The field emission point part may include a material including one of molybdenum, tungsten, and carbon nanotube.

The field emitter may include a power source applying voltage to the cathode, the first anode, and the second anode.

In other exemplary embodiments of the present invention, a method of operating a field emitter including a cathode, a field emission point part disposed on a first surface of the cathode and electrically connected to the cathode, a first anode facing the field emission point part, a charge storing plate disposed at a second surface of cathode and a second anode corresponding to the second surface and interposing the charge storing plate between the second anode and the second surface, the method including storing charges on both edges of the charge storing plate by applying voltage to the cathode and the second anode and emitting charges from the field emission point part to the first anode by applying voltage to the cathode and the first anode.

In still other exemplary embodiments of the present invention, a method of enhancing field emission of a field emitter, the field emitter including a cathode, a field emission point part disposed on a first surface of the cathode, and a first anode facing the first surface of the cathode, includes disposing a charge storing plate on a second surface of the cathode, a first surface of the charge storing plate contacting the second surface of the cathode, disposing a second anode on a second surface of the charge storing plate, controlling voltages applied to the cathode and the second anode during a storage stage to accumulate electric charges on the charge storing plate, controlling voltages applied to the first anode and the cathode during an emitting stage to emit electrons from the field emission point part, and controlling voltages applied to the cathode and the second anode during the emitting stage to release the electric charges accumulated on the charge storing plate.

According to the above, the ferroelectric charge storing plate is disposed on the cathode so that a field emission property is enhanced more than that of a conventional field emitter, although an intensity of an electric field is not increased.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a cross-sectional view showing an exemplary field emitter in accordance with an exemplary embodiment of the present invention;

FIG. 2 is a perspective view showing a perovskite crystalline structure, which is a representative crystalline structure of a ferroelectric composing a charge storing plate in FIG. 1;

FIG. 3 is a cross-sectional view showing a storing stage of the exemplary field emitter in FIG. 1; and

FIG. 4 is a cross-sectional view showing an emitting stage of the exemplary field emitter in FIG. 1.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

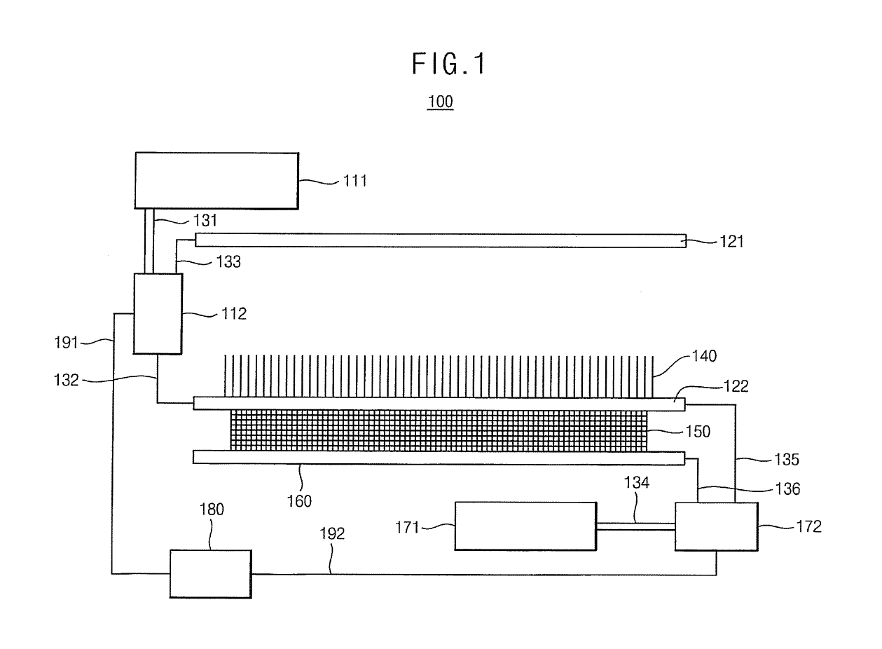

FIG. 1 is a cross-sectional view showing an exemplary field emitter in accordance with an exemplary embodiment of the present invention.

Referring to FIG. 1, a field emitter 100 in accordance with an exemplary embodiment of the present invention includes a first voltage applying device 111, a first voltage controlling device 112, a first anode 121, a cathode 122, a field emission point part 140, a charge storing plate 150, a second anode 160, a second voltage applying device 171, a second voltage controlling device 172, and a third voltage controlling device 180.

The first voltage applying device 111 is electrically connected to the first voltage controlling device 112 by a first line 131. A voltage from the first voltage applying device 111 is controlled by the first voltage controlling device 112 to be applied to the first anode 121 and the cathode 122.

The first voltage controlling device 112 is electrically connected to the cathode 122 by a second line 132, and is electrically connected to the first anode 121 by a third line 133.

The first voltage controlling device 112 controls the voltage applied to the first anode 121 and the cathode 122, thereby controlling an emitting stage of the field emitter 100.

For example, the first anode 121 may include indium tin oxide (“ITO”) and a thickness of the first anode 121 may be within a range of about 10 nm to about 1 μm. Alternatively, the first anode 121 may include indium zinc oxide (“IZO”), amorphous indium tin oxide (“a-ITO”), etc. The first anode 121 includes a surface facing the cathode 122.

A thickness of the cathode 122, for example, may be within a range of about 10 nm to about 1 μm, and the cathode 122 may include nickel (Ni), titanium nitride (TiN), calcium (Ca), magnesium (Mg), etc. The cathode 122 includes a first surface facing the surface of the first anode 121 and a second surface corresponding to and opposite the first surface. The cathode 122 and the first anode 121 are spaced apart from each other as shown.

The field emission point part 140 is disposed on the first surface of the cathode 122, such that the field emission point part 140 is between the cathode 122 and the first anode 121.

When the voltage is applied to the first anode 121 and the cathode 122 from the first voltage applying device 111, a strong electric field is applied to the field emission point part 140.

The field emitter 100 further includes the charge storing plate 150 disposed on the second surface of the cathode 122, such that the cathode 122 is disposed between the field emission point part 140 and the charge storing plate 150. The charge storing plate 150 includes ferroelectric. For example, the charge storing plate 150 includes ferroelectric having a perovskite crystalline structure. A first surface of the charge storing plate 150 faces the second surface of the cathode 122, and further contacts the second surface of the cathode 122

The charge storing plate 150 is interposed between the cathode 122 and the second anode 160. A surface of the second anode 160 faces the second surface of the cathode 122, and faces and contacts a second surface of the charge storing plate 150. The second anode 160 and the cathode 122 form an electric field.

A thickness of the second anode 160, for example, may be within a range of about 10 nm to about 1 μm, and the second anode 160 may include platinum (Pt), gold (Au), copper (Cu), etc.

The second voltage applying device 171 is electrically connected to the second voltage controlling device 172 by a fourth line 134. The second voltage controlling device 172 controls the application level of the voltage from the second voltage applying device 171 to be applied to the second anode 160 and the cathode 122.

The second voltage controlling device 172 and the cathode 122 are electrically connected to each other by a fifth line 135. The second voltage controlling device 172 and the second anode 160 are electrically connected to each other by a sixth line 136.

The second voltage controlling device 172 applies the voltage to the cathode 122 and the second anode 160, and controls a storing stage of the field emitter 100.

Ferroelectric constituting the charge storing plate 150 includes electric dipole moment. When the electric field is applied to the ferroelectric, the electric dipole moment is arranged along the direction substantially parallel to the electric field.

When the electric field is applied to opposite ends of the ferroelectric, an electric dipole moment in the ferroelectric is arranged along the electric field, thus the ferroelectric has an order in view of long distance.

In the arranging process, opposite charges are accumulated on the electrodes 122 and 160, that is, the cathode 122 and the second anode 160. The electrodes 122 and 160 make contact with opposite surfaces of the ferroelectric in the charge storing plate 150. Thus, electric unbalance of the ferroelectric, which is caused by arrangement of the electric dipole moment, is decreased.

When the first surface of the charge storing plate 150 including ferroelectric is disposed on the second surface of the cathode 122 and the field emission point part 140 is disposed on the first surface of the cathode 122 as shown, charge density accumulated on the cathode 122 is increased more than a field emitter not having the charge storing plate 150.

Therefore, even if substantially a same electric field is applied, a field emission property of the field emitter having the charge storing plate 150 is more enhanced than the field emitter not having the charge storing plate 150.

The first voltage controlling device 112 and the second voltage controlling device 172 are electrically connected to a third voltage controlling device 180 to control the first voltage controlling device 112 and the second voltage controlling device 172, thereby controlling an emitting stage and a storing stage of the field emitter 100, in sequence.

The first voltage controlling device 112 and the third voltage controlling device 180 are connected to each other by a first communication line 191. The second voltage controlling device 172 and the third voltage controlling device 180 are connected to each other by a second communication line 192.

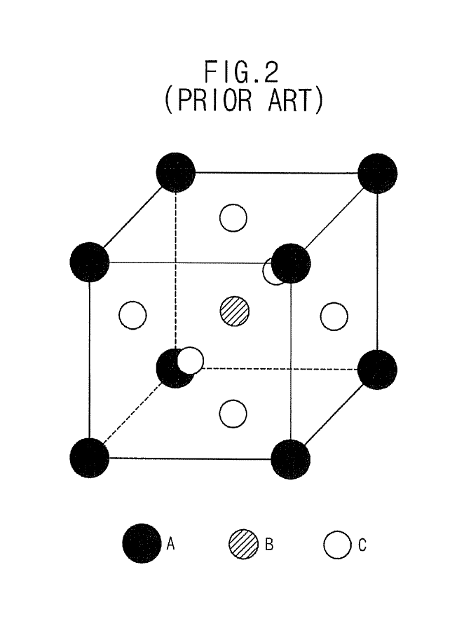

FIG. 2 is a perspective view showing a perovskite crystalline structure, which is a representative crystalline structure of the ferroelectric composing an exemplary charge storing plate in FIG. 1.

In a perovskite structure, eight cations are disposed at corners A of a cube, and another cation is disposed in a center B of the cube. In addition, six anions are disposed at centers O of surfaces of the cube.

When the perovskite structure is a cube, the cube is isotropic. Thus, the perovskite structure does not have an electric dipole moment. This phenomenon generally occurs at high temperatures.

When the temperature goes down, phase in the perovskite structure transits from a cube to a tetragonal structure, a monoclinic structure, an orthorhombic structure, and a rhombohedral structure with increase of anisotropy.

Through the phase transition, the crystal has an electric dipole moment, and a material having a perovskite structure is ferroelectric or anti-ferroelectric.

In a perovskite structure having ferroelectric properties, a first ion such as lead Pb, barium Ba, strontium Sr, bismuth Bi, and lanthanum La is disposed at each corner A. A second ion selected from titanium Ti, zirconium Zr, zinc Zn, magnesium Mg, niobium Nb, and tantalum Ta ions is disposed in the middle B of the unit cell. An oxygen anion O is disposed at the center C of each unit cell face.

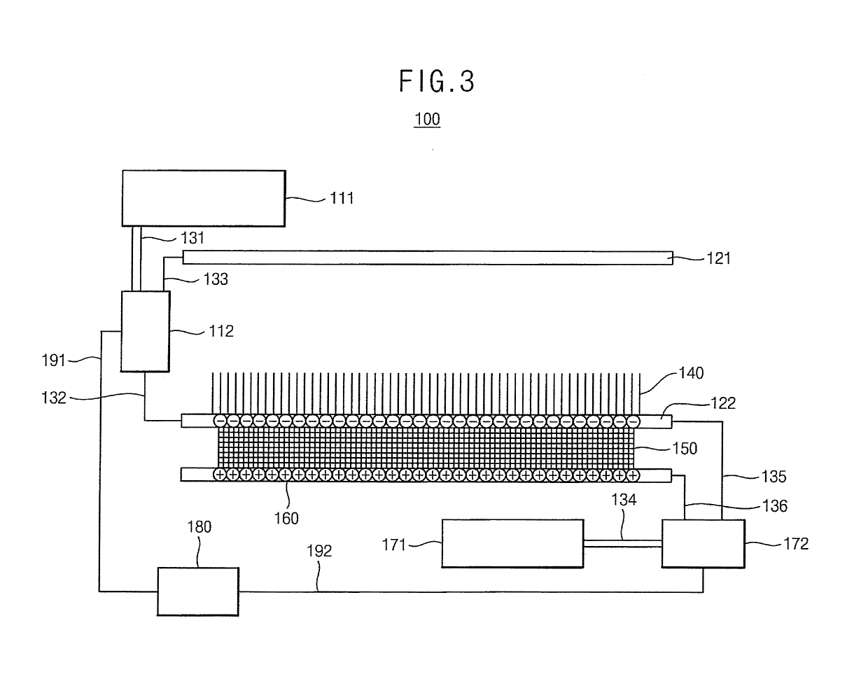

FIG. 3 is a cross-sectional view showing a storing stage of the exemplary field emitter in FIG. 1.

Referring to FIG. 3, the second voltage applying device 172 applies a relatively lower voltage to the cathode 122 than the voltage applied to the second anode 160, and the second voltage applying device 172 applies a relatively higher voltage to the second anode 160 than the voltage applied to the cathode 122. The second voltage controlling device 172 controls the application level and time of the voltages.

According to the above, an electric field is formed between the cathode 122 and the second anode 160. The electric dipole moment is arranged in the charge storing plate 150 including the ferroelectric. As a result, electric charges accumulate on the charge storing plate 150. For example, anions accumulate on the cathode 122, and cations accumulate in the second anode 160.

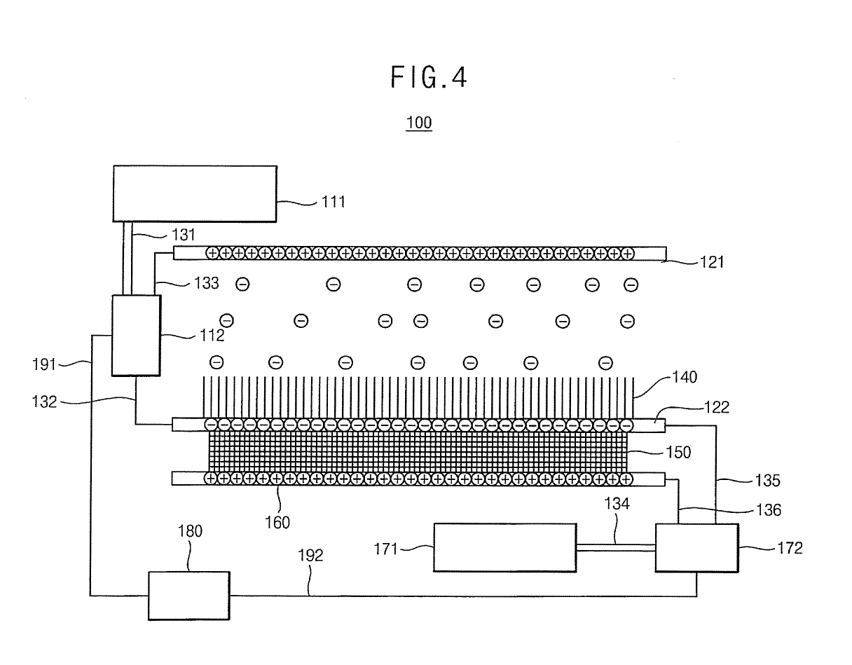

FIG. 4 is a cross-sectional view showing an emitting stage of the exemplary field emitter in FIG. 1.

Referring to FIG. 4, the first voltage controlling device 112 controls the level of the voltage from the first voltage applying device 111 so that the voltage is applied to the first anode 121 and the cathode 122.

A relatively lower voltage is applied to the cathode 122 than a voltage applied to the first anode 121, and a relatively higher voltage is applied to the first anode 121 than a voltage applied to the cathode 122.

When voltage controlled by the first voltage controlling device 112 is applied to the cathode 122 and the first anode 121, electrons are emitted from the field emission point part 140 and the electrons move toward the first anode 121.

In the emitting stage, voltage applied to the charge storing plate 150 is controlled by the second voltage controlling device 172, and the level of voltage applied to the charge storing plate 150 becomes smaller than the level of voltage applied to the charge storing plate 150 in the storing stage.

When the level of voltage applied to the charge storing plate 150 is decreased by the second voltage controlling device 172, the long distance order of the electric dipole moment of the ferroelectric of the charge storing plate 150 is relaxed so that anions captured on the cathode 122 are emitted through the field emission point part 140.

In the exemplary embodiment of the present invention, the first surface of the charge storing plate 150 including ferroelectric is attached onto the second surface of the cathode 122 in which a field emission happens, and the second anode 160 is formed on the second surface of the charge storing plate 150 so that the number of electrons accumulated on the cathode 122 is increased more than a field emitter without the charge storing plate 150. As a result, the amount of current density emitted from field emission point part 140 is increased in the emitting stage.

Although substantially the same voltage is applied to the exemplary field emitter of the present invention and to a convention field emitter on the basis of Fowler-Nordheim (“FN”) tunneling, the exemplary field emitter in accordance with the present invention is capable of increasing the amount of current density emitted from the field emission point part 140 compared with the conventional field emitter, which does not have the charge storing plate 150 and has a various geometric shape of a field emission point part.

According to the present invention, a first surface of the charge storing plate including ferroelectric is attached to the second surface of the cathode in which a field emission happens, and the second anode is formed on a second surface of the charge storing plate. Thus, the number of electrons accumulated on the cathode is increased compared to the field emitter without the charge storing plate.

Therefore, although substantially the same electric field is formed in the field emitter, the exemplary field emitter of the present invention induces a more effective field emission current than the field emitter without the charge storing plate.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A field emitter comprising:
a cathode;
a field emission point part disposed on a first surface of the cathode and electrically connected to the cathode;
a first anode facing the field emission point part;
a charge storing plate disposed on a second surface of the cathode, the second surface being opposite to the first surface; and
a second anode facing the second surface of the cathode, interposing the charge storing plate between the second anode and the second surface of the cathode.

2. The field emitter of claim 1, wherein the charge storing plate comprises ferroelectric.

3. The field emitter of claim 2, wherein the ferroelectric has a perovskite crystalline structure.

4. The field emitter of claim 1, wherein a thickness of the charge storing plate is within a range of about 10 nm to about 1 μm.

5. The field emitter of claim 1, wherein the field emission point part comprises at least one material including one of molybdenum, tungsten, and carbon nanotube.

6. The field emitter of claim 1, wherein the cathode comprises at least one material including one of nickel, titanium nitride, calcium, and magnesium.

7. The field emitter of claim 1, wherein the first anode comprises indium tin oxide.

8. The field emitter of claim 1, wherein the second anode comprises at least one material including one of platinum, gold, and silver.

9. The field emitter of claim 1, further comprising:
a power source applying voltage to the cathode, the first anode, and the second anode.

10. The field emitter of claim 9, wherein the power source comprises:
a first voltage applying device applying a first voltage to the cathode and the first anode;
a first voltage controlling device connected to the first voltage applying device and controlling application level and time of the first voltage applied to the cathode and the first anode;
a second voltage applying device applying a second voltage to the cathode and the second anode; and
a second voltage controlling device connected to the second voltage applying device and controlling application level and time of the second voltage applied to the cathode and the second anode.

11. The field emitter of claim 10, further comprising a third voltage controlling device connected to the first and second voltage controlling devices.

12. The field emitter of claim 1, wherein, during a storage stage of the field emitter, a voltage applied to the second anode is higher than a voltage applied to the cathode.

13. The field emitter of claim 12, wherein, during an emitting stage of the field emitter, a voltage applied to the first anode is higher than a voltage applied to the cathode, and a level of voltage applied to the charge storing plate during the storage stage decreases during the emitting stage.

14. The field emitter of claim 12, further comprising a voltage controlling device controlling a voltage applied to the charge storing plate to increase a number of electrons accumulated on the cathode.

15. A method of operating a field emitter including a cathode, a field emission point part disposed on a first surface of the cathode and electrically connected to the cathode, a first anode facing the field emission point part, a charge storing plate disposed at a second surface of the cathode, and a second anode facing the second surface of the cathode and interposing the charge storing plate between the second anode and the second surface of the cathode, the method comprising:
applying a first voltage to the cathode and the second anode to store charges on opposite edges of the charge storing plate; and
applying a second voltage to the cathode and the first anode to emit charges from the field emission point part to the first anode.

16. A method of enhancing field emission of a field emitter, the field emitter including a cathode, a field emission point part disposed on a first surface of the cathode, and a first anode facing the first surface of the cathode, the method comprising:
disposing a charge storing plate on a second surface of the cathode, a first surface of the charge storing plate contacting the second surface of the cathode;
disposing a second anode on a second surface of the charge storing plate;
controlling voltages applied to the cathode and the second anode during a storage stage to accumulate electric charges on the charge storing plate;
controlling voltages applied to the first anode and the cathode during an emitting stage to emit electrons from the field emission point part; and,
controlling voltages applied to the cathode and the second anode during the emitting stage to release the electric charges accumulated on the charge storing plate.

17. The method of claim 16, wherein controlling voltages applied to the cathode and the second anode during a storage stage includes applying a voltage to the second anode that is higher than a voltage applied to the cathode.

18. The method of claim 17, wherein controlling voltages applied to the first anode and the cathode during an emitting stage includes applying a voltage to the first anode that is higher than a voltage applied to the cathode.

19. The method of claim 18, wherein controlling voltages applied to the cathode and the second anode during the emitting stage includes reducing a level of a voltage applied to the charge storing plate to a level less than a level of a voltage applied to the charge storing plate during the storage stage.

20. The method of claim 16, wherein disposing a charge storing plate on a second surface of the cathode includes disposing a charge storing plate including a ferroelectric material on the second surface of the cathode.
